(19) United States
(12) Patent Application Publication
(10) Pub. No.: US 2005/0075138 A1
(43) Pub. Date: Apr. 7, 2005

(54) Low profile electronic card holder and device using same

(76) Inventors: Kevin D. Page, West Palm Beach, FL (US); Douglas W. Moskowitz, Weston, FL (US); Francis M. Staszesky, Ft. Lauderdale, FL (US)

Correspondence Address: Larry G. Brown;Motorola, Inc., Law Department, 8000 West Sunrise Boulevard, Fort Lauderdale, FL, 33322, US

(21) Appl. No.: 10/679,518

(22) Filed: Oct. 6, 2003

(51) Int. Cl. H04Q 7/32

(52) U.S. Cl. 455/559; 455/575.1; 455/572

(57) ABSTRACT

A memory card tray (206) includes a low profile design having a flat outside ledge (302) that allows for the memory card tray (206) to be welded flush to the electronic device. Angled leading edges (304) help with the insertion of the memory (SIM) card (102). A ramp (305) found in the trailing edge of the tray (206) provides for easier removal of the SIM card (102) via an access opening (106) found in the electronic device's battery floor.

### TECHNICAL FIELD

This invention relates in general to the field of electronics and more specifically to an electronic card holder and an electronic device using the card holder.

### BACKGROUND

With the constant marketplace pressure to keep reducing the overall size of portable electronic devices, such as mobile telephones, one of the major areas of concern when designing a new mobile telephone is its overall size. An area that can be targeted to reduce overall product volume is in the implementation of memory card (also known as smart card) systems such as Subscriber Identity Module (SIM) card systems used in mobile telephones and other electronic devices. Past mobile telephones have utilized off-the-shelf smart card holders that for example integrate the cardholder into the plastic battery floor of the mobile telephone. Off-the-shelf memory smart card holders are typically too large in size and take up too much internal volume. Molding the smart card retention system into the battery floor is at times expensive and not feasible when the battery floor is made of sheet metal as is the case with many present day electronic devices which are concerned with radio frequency interference.

Furthermore, some of these card retention systems introduce bypass or access holes which allow for audio to leave the product which degrades the product's audio performance and also provides paths for water, noise, dirt and other damaging environmental factors to enter the product. Given the above, a need exists in the art for an apparatus for retaining a memory card in an electronic device which helps alleviate one or more of the problems mentioned above.

### BRIEF DESCRIPTION OF THE DRAWINGS

The features of the present invention, which are believed to be novel, are set forth with particularity in the appended claims. The invention may best be understood by reference to the following description, taken in conjunction with the accompanying drawings, in the several figures of which like reference numerals identify like elements, and in which:

FIG. 1 shows a portable communication device having a SIM card holder and SIM card in accordance with an embodiment of the invention.

FIG. 2 shows a memory card tray attached to a battery floor in accordance with an embodiment of the invention.

FIG. 3 shows an isometric view of the memory card tray in accordance with an embodiment of the invention.

### DETAILED DESCRIPTION OF THE PREFERRED EMBODIMENT

While the specification concludes with claims defining the features of the invention that are regarded as novel, it is believed that the invention will be better understood from a consideration of the following description in conjunction with the drawing figures.

Referring to FIG. 1, there is shown an electronic device 100 such as a portable radio telephone (also referred to as a cellular telephone or radio) having a memory card holder in accordance with an embodiment of the invention. The portable communication device 108 includes an aperture 104 for receiving an electronic card or memory card such as a SIM card 102. The SIM card 102 is typically used to load user specific information into radio 108.

Radio telephone 108 is shown without its battery cover in place in order to highlight the SIM card access opening 106 which allows the user to remove the SIM card 102 out of the radio telephone 108. If the SIM card 102 has to be removed, a person simply removes the battery cover and battery and pushes the SIM card 102 out by pushing the card out with his/her finger through opening 106. The design of the SIM card access opening 106 is such that no special tools are required to remove the SIM card 102 once it is loaded into the portable telephone 108. Prior art smart card systems require the use of a special tool(s) to remove the SIM card once it is loaded into the SIM carrier.

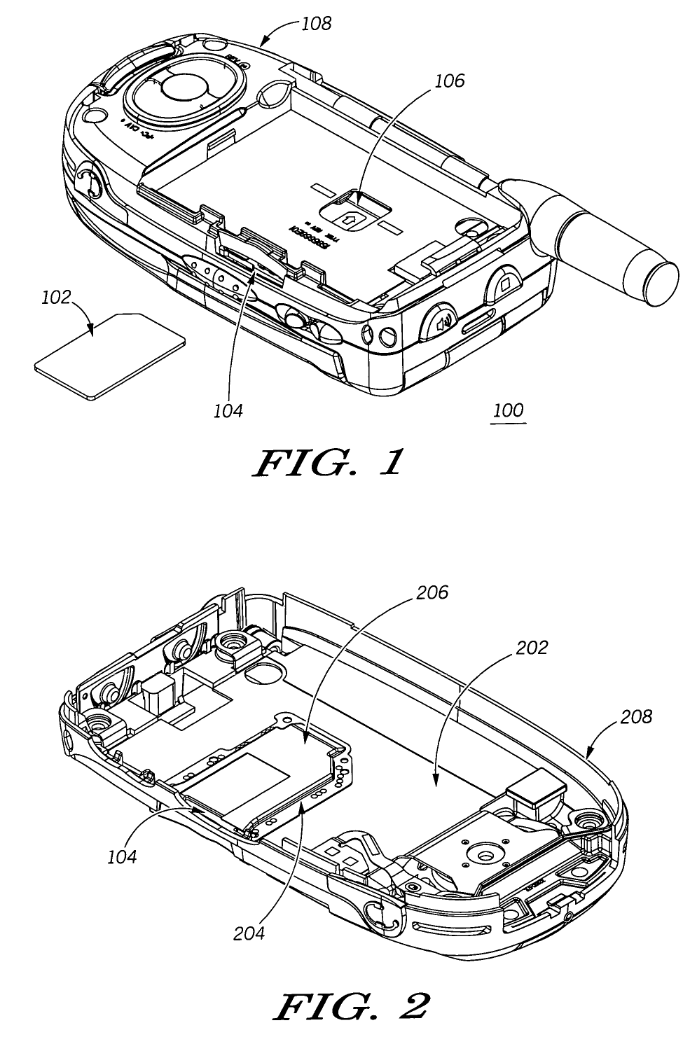

In FIG. 2, there is shown the memory card or SIM card tray 206 attached to the battery floor 202 found in housing 208. In one embodiment, the SIM tray 206 is manufactured from sheet metal such as stainless steel and can be welded directly on to a metal battery floor 202. This design provides for a very low profile card holder which is inexpensive to manufacture. Alternatively, the battery floor 202 and the SIM tray 206 can be made out of other materials such as plastic, etc. If plastic is used, the SIM tray 206 can be ultrasonically welded to the battery floor 202 or other fastening techniques can be used.

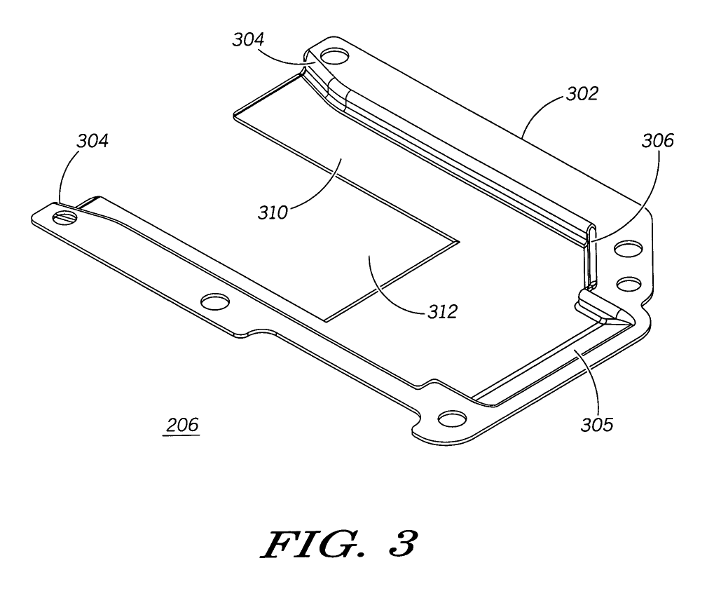

The sheet metal used to manufacture the SIM tray 206 in one embodiment is approximately 0.20 millimeters (mm) thick and has a thickness tolerance of 0.02 mm. The design introduces a low profile design which takes up minimal space inside of the radio telephone 108 and helps reduce system design thickness. The SIM tray can be shaped and formed from a piece of sheet metal so it is fairly inexpensive to manufacture. The SIM tray 206 helps guide and center the SIM card 102 as it is being inserted. The SIM card's electrical contacts (not shown) are directed by the tray 206 to the corresponding connector contacts (not shown) found on a printed circuit board inside of the radio telephone 108. The printed circuit board would lie above the battery floor 202, with the SIM contacts being exposed through an opening in the SIM tray (see opening 312 in FIG. 3).

Referring to FIG. 3, there is shown an isometric view of the metal SIM tray 206. SIM tray 206 can be manufactured from a metal such as stainless steel. The SIM tray in the preferred embodiment has an overall height (from battery floor to top of tray) of approximately 1.2 mm. The SIM card 102 has a thickness of approximately 0.76 mm. There is minimal wasted height with the formed metal tray of the present invention, and it provides for a snug fit which reduces SIM card bounce once the SIM card is loaded. The SIM tray 206 includes angled ends 304 at the entry point for the SIM card 102 in order to properly guide the SIM card 102 into the tray 206. The SIM tray also includes a ceiling 310 which helps retain the SIM card 102 when it is slid into the tray 206. The tray ceiling 310 and the battery floor 202 help retain the SIM card 102 in place once it is inserted into the tray 206.

The tray ceiling 310 has a cut out 312 which allows the SIM card electrical contacts (not shown) to make electrical contact to contacts found on a printed circuit board (not shown) located inside of mobile radio 108. The flat outside ledge 302 lays flat against the metal battery floor 202 and allows the tray 206 to be attached to the battery floor 202. The flat outside ledge 302 surrounds the SIM tray except where the SIM card is inserted into the SIM tray 206. The SIM tray 206 can be attached in a number of ways, such as by laser welding the tray 206 on to the battery floor 202. Other attachment techniques can include the use of adhesives, or other types of fastening techniques. As shown in FIG, 3, the SIM tray 206 is flip over and the flat outside ledge 302 is rested in alignment over battery floor 202 prior to the SIM tray 206 being welded. The SIM tray can include alignment apertures for use in placement onto the battery floor if desired.

An angled notch 306 matches the notch found in SIM card 102. Notch 306 prevents the SIM card 102 from being inserted in the wrong way since the notch 306 will not allow an improperly inserted SIM card to be fully inserted into tray 206. A ramp 305 in the trailing edge of the tray helps with the removal of the SIM card when used in association with the removal aperture 106. The ramp 305 is aligned with the access opening 106 and allows a person to slide a finger or pen and push the SIM card out through SIM card aperture 104.

The use of a formed or stamped sheet metal tray 206 to align and enclose the SIM card 102 helps provide for a very low profile SIM retention tray which helps reduce product thickness. Using a single or integral piece of sheet metal which is formed or stamped into shape helps reduce the cost of the tray. The design also helps eliminate any extra openings in the battery floor which keeps out any damaging environmental factors such as water and dust which may damage the internal electronics.

While the preferred embodiments of the invention have been illustrated and described, it will be clear that the invention is not so limited. Numerous modifications, changes, variations, substitutions and equivalents will occur to those skilled in the art without departing from the spirit and scope of the present invention as defined by the appended claims.

1. An electronic device that accepts a removable memory card, the electronic device comprising:
a housing; and
a low profile metal memory card tray having a flat outside ledge, the memory card tray is attached to the housing.

2. An electronic device as defined in claim 1, wherein the low profile metal memory card tray is laser welded at the flat outside ledge to the housing.

3. An electronic device as defined in claim 1, wherein the housing includes a metal battery floor and the low profile metal memory card tray is laser welded to the metal battery floor.

4. An electronic device as defined in claim 3, wherein the electronic device comprises a mobile telephone.

5. An electronic device as defined in claim 3, wherein the low profile metal card tray includes angled leading edges which help load the removable memory card into the tray.

6. An electronic device as defined in claim 3, wherein the low profile metal card tray includes a ramp in its trailing edge which facilitates the removal of the removable memory card from the low profile memory card tray.

7. An electronic device as defined in claim 6, wherein the housing includes an access opening and the ramp found in the low profile metal card tray is aligned with the access opening.

8. An electronic device as defined in claim 7, wherein the low profile metal card tray includes an angled notch which helps prevent the removable memory card from being loaded into the low profile metal card tray incorrectly.

9. An electronic device as defined in claim 8, wherein the removable memory card comprises a Subscriber Identity Module (SIM).

10. An electronic device as defined in claim 8, wherein the low profile metal card tray is manufactured from stainless steel.

11. A low profile memory card tray for use in retaining a memory card, the low profile memory card tray comprising:
a sheet metal member having a flat outside ledge; and
the sheet metal member has angled leading edges which help load the memory card into the tray.

12. A low profile memory card tray as defined in claim 11, wherein the sheet metal member is formed from stainless steel.

13. A low profile memory card tray as defined in claim 11, wherein the sheet metal member includes a ramp in its trailing edge which facilitates the removal of the memory card from the low profile memory card tray.

14. A low profile memory card tray as defined in claim 13, wherein the sheet metal member includes an angled notch which helps prevent the memory card from being improperly loaded into the low profile memory card tray.

15. A low profile memory card tray as defined in claim 11, wherein the sheet metal member is an integral piece of sheet metal which is stamped into shape.

16. A memory card retention system, comprising:
an electronic device housing member; and
a low profile memory card tray having a flat outside ledge, the memory card tray is attached to the electronic device housing member.

17. A memory card retention system as defined in claim 16, wherein the low profile memory card tray is welded to the electronic device housing member.

18. A memory card retention system as defined in claim 16, wherein the memory card tray is comprised of metal and is stamped into shape.

19. A memory card retention system as defined in claim 16, wherein the electronic device housing member comprises a battery floor for a radio communication device.

20. A memory card retention system as defined in claim 16, wherein the memory card tray has an overall height of no more than 1.2 millimeter.
